(19) United States
(12) Patent Application Publication
(10) Pub. No.: US 2025/0074010 A1
(43) Pub. Date: Mar. 6, 2025

(54) METHOD AND APPARATUS FOR BONDING REINFORCED HDPE PIPES

(71) Applicant: Robert David Jones, III, Pearland, TX (US)

(72) Inventor: Robert David Jones, III, Pearland, TX (US)

(21) Appl. No.: 18/238,865

(22) Filed: Aug. 28, 2023

(51) Int. Cl. B29C 65/00; F16L 13/02

(52) U.S. Cl. CPC B29C 66/5229; B29C 66/5221; B29C 66/5223; B29C 66/52241; B29C 66/73921; B29C 66/91413; B29C 66/944; F16L 13/0209

(57) ABSTRACT

A method of heat welding a length of pipe with a coupling is disclosed. The coupling and the length of pipe are of a thermoplastic material. The method includes preparing a first end of the length of pipe; preparing a first groove of the coupling, wherein the first groove is configured to mechanically interface to an inner diameter (ID) and outer diameter (OD) of the length of pipe; heating the first and the first groove to a weldable temperature; joining the first end to the first groove; and permitting the first end and the first groove to cool sufficiently long to form a thermoplastic weld.

### FIELD OF THE SPECIFICATION

This application relates generally to fluid structures and more particularly, though not exclusively, to a method and apparatus for coupling high density polyethylene (HDPE) piping.

### BACKGROUND

HDPE is a synthetic polymer thermoplastic that is often used for pipes, which may carry water, gas, hydrocarbons, or other materials. A commonly known and standards-compliant method of coupling two lengths of HDPE piping together is butt welding, in which the two pipes are prepared and heated, and then forced together such that the ends melt together and form a secure bond.

### BRIEF DESCRIPTION OF THE DRAWINGS

The present disclosure is best understood from the following detailed description when read with the accompanying FIGURES. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion. Furthermore, the various elements illustrated herein disclose only one illustrative arrangement of those elements. Illustrated elements may be rearranged in different configurations, and elements shown in one configuration may, in appropriate circumstances, be moved to a different arrangement or configuration.

FIG. 1 is a perspective view illustration of HDPE piping.

FIGS. 2A, 2B, and 2C illustrate a thermoplastic welding system.

FIG. 3 is a flowchart of a method.

FIG. 4 is a cutaway front view of selected HDPE piping.

FIG. 5 is a cutaway front view of a reinforced HDPE pipe.

FIG. 6A is a side view of an HDPE bonded system with a straight coupling.

FIG. 6B is a side view of an HDPE bonded system with an elbow joint coupling.

FIG. 6C is a side view of an HDEP bonded system with a tee joint coupling.

FIG. 7 is a perspective view of a straight coupling.

FIG. 8 is a cutaway side view of the coupler of FIG. 7.

FIG. 9 is a perspective view illustration of a pair of pipes bonded to a coupler.

FIG. 10 is a cutaway view of the bonded pipes of FIG. 9.

FIGS. 11A, 11B, and 11C illustrate selected aspects of a heating element.

FIGS. 12A, 12B, and 12C illustrate configurations of a preparation insert.

FIG. 13 is a flowchart of a method of joining two HDPE pipes with an HDPE coupling.

FIG. 14 illustrates a pipe end coupling system.

### SUMMARY

A method of heat welding a length of pipe with a coupling is disclosed. The coupling and the length of pipe are of a thermoplastic material. The method includes preparing a first end of the length of pipe; preparing a first groove of the coupling, wherein the first groove is configured to mechanically interface to an inner diameter (ID) and outer diameter (OD) of the length of pipe; heating the first and the first groove to a weldable temperature; joining the first end to the first groove; and permitting the first end and the first groove to cool sufficiently long to form a thermoplastic weld

### Embodiments of the Disclosure

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

### Overview

Thermoplastics are a class of polymers that can be heated and cooled repeatedly and still retain their material properties and strength. Some thermoplastics, such as polyvinyl chloride (PVC) can be readily bonded with general purpose solvent cements that slightly dissolve both sides of a joint, so that when the joint cures, a strong bond is formed.

However, other thermoplastics are not readily cementable, in that they do not easily interact with general purpose cements. For some of these (such as HDPE), specialized cements are available, but these may be expensive, may have long cure times (e.g., 5 days or more), and/or may form joints that are not pressure rated. Examples of thermoplastics that are not readily cementable include polypropylene (PP), polyethylene (PE), high-density polyethylene (HDPE), low-density polyethylene (LDPE), linear low-density polyethylene (LLDPE), polyethylene terephthalate (PET), polytetrafluoroethylene (PTFE), polycarbonate (PC), and polyvinylidene fluoride (PVDF). For these thermoplastics, thermal welding may provide superior bonding.

Throughout this specification, HDPE is used as an illustrative embodiment to illustrate the principles of operation. The systems and methods disclosed herein may be readily adapted to other thermoplastics, such as those listed above, or any other suitable thermoplastic.

HDPE pipes come in a variety of inside diameters and wall thicknesses. The inside diameter of a pipe may be as small as a fraction of an inch (e.g., ¼ inch, ½ inch, ¾ inch, or other), and as large as several inches (e.g., 1 inch, 2 inches, 3 inches, 5 inches, 6 inches, or other). Very large pipes may have an inside diameter as large as 136 inches. The pressure rating of the pipe will depend not only on the inside diameter of the pipe, but also on the wall thickness. Common HDPE pipes may be rated for pressures of 100 to 335 psi.

For pure HDPE pipes, the commonly known and standards-compliant method of bonding two lengths of pipe together is known as butt welding. Butt welding involves preparing the pipes, such as by cleaning and facing the pipe ends, and ensuring that the two pipe ends are completely clean and parallel. A heater may then be applied for a specified time simultaneously to the butt ends of the two pipes. After the specified time, the heater is removed and the two butt ends of the pipe are forced together at a specified pressure. The melted ends of the two pipes weld together, with an exterior bead forming around the joint. If all goes well and the butt weld is performed correctly, a strong bond is formed and may in fact be stronger than the original pipe. Butt welding is the only method approved by the current version of ASTM International's standard F2620. While there are cements, such as two-part epoxies, that can bond to HDPE, they have not been found to form bonds that can be rated up to the nominal pressure of the HDPE pipe.

While butt welding is useful for 100% HDPE piping, the process is highly sensitive to disturbances. Standards-compliant processes require that both pipes be faced with a facer that shaves material off the end of the pipe to make sure it is clean and straight. The two pipes are aligned in an armature and the abutting faces must be clean, parallel, and aligned with near perfection. The operator is directed to take care that no contamination accumulates on the faced piping during the process. If, at the end of the process or at any time during the process any contamination is found on the weld joint, the two pipes are found to not be parallel, or a good, uniform bead does not form, then the pipes must be cut and the process started over.

Contamination is a particular concern for HDPE butt welding, in part because there is a relatively small contact surface between the two pipes. The weld forms completely on the rim (butt end) of the pipe, which in many applications has a wall thickness of less than 1 inch. Any contamination between the two faces may result in an incomplete HDPE weld, and a weakened joint. This may compromise the pressure rating of the pipe and make it unsuitable for its intended purpose.

HDPE joints generally do not use couplers like those used for PVC fittings, because such fittings use a bonding cement. Presently, there is not a known standards-compliant bonding cement for bonding HDPE for high-pressure applications. Thus, butt welding is currently the only standards-compliant method of joining two lengths of HDPE pipe, per ASTM F2620.

Recent applications have arisen in which HDPE piping would be beneficial and suitable, except that the pressures involved are greater than the ratings of common HDPE pipes. In the oil and gas industry in particular, certain applications may exceed the pressure rating of common HDPE pipes. These may include, for example, a long downhill slope that develops head pressure up to 1500 PSI. In some cases, it may also be desirable to replace steel pipes rated up to 1500 PSI with HDPE pipes, because ambient soil conditions, or the fluid that flows through the pipe, may have corrosive properties that eventually degrade or destroy metallic pipes. Such applications may benefit from reinforced HDPE pipes. Reinforced pipes may have a sandwich configuration, in which inner and outer layers of HDPE surround a reinforcing material such as a metal or fiberglass. Fiberglass is particularly popular for reinforcing HDPE pipes because it is less expensive than most metals, provides sufficient strength, and is easier to work with as it is less rigid than metal reinforcement. Reinforced HDPE pipes of this type may have a sufficient pressure rating to handle desired applications, such as oil and gas applications.

One difficulty with such reinforced pipes is that, by definition, the reinforcing material is not HDPE. Using fiberglass as an example, if a technician wants to join two lengths of fiberglass-reinforced HDPE pipe, he may cut the two lengths of pipe and join them together using the butt welding process previously described. But as described, the butt welding process is highly sensitive to contamination. In this case, the fiberglass reinforcement that gives the pipe its increased pressure rating is also a contaminant in the butt welding process. Because the butt weld is inherently contaminated in a reinforced pipe, the very material that gives the HDPE pipe its increased pressure rating also compromises the pressure rating of the butt weld. This makes it difficult to use HDPE pipes in applications such as oil and gas, where it would otherwise be appropriate and beneficial.

The present specification describes a method and apparatus for bonding lengths of reinforced or unreinforced HDPE using a novel pressure coupling. The coupling described herein includes an interior raceway or groove that is sized to snugly receive the rim of an HDPE pipe. The coupling is constructed of HDPE and may be heated similarly to the current HDPE butt welding process. In an illustrative process, the HDPE pipe is cut and optionally faced as in existing standards. The end of the pipe may also be cleaned either by facing both the inside and outside diameter, by scraping or abrading, or by using a chemical solvent.

Similarly, the face and raceway or groove of the coupling may be cleaned by facing, scraping, abrading, or by using a chemical solvent. The face of the HDPE pipe is heated, as well as the raceway and sidewalls of the HDPE coupling. In this case, the heating time between the pipe and the coupling may be different, because they may have different thicknesses that require adjusted heating times. Once both are adequately heated, the HDPE pipe is pressed into the raceway of the coupling.

As described above, if the HDPE pipe is reinforced (such as by metal or fiberglass), then the face of the pipe may experience contamination, and therefore a weaker bond where it abuts the coupling. This is acceptable, however, because the primary pressure-bearing bond is not at the abutment of the pipe end to the inside of the groove, but along the inner wall of the groove and the inner diameter of the HDPE pipe. This bond may be completely or mostly uncontaminated, and thus may form a strong HDPE weld. The coupling may also be made so that the length of the groove along the sidewall of the pipe is greater than the existing wall thickness of the same pipe, thus providing a bond with a greater surface area than in existing methods. Thus, pressure within the pipe will be incident on this novel weld joint, which is stronger than the contaminated weld joint between the face and the coupling, and which may be stronger than known ASTM F2620 weld joints.

Furthermore, n some embodiments, welding at the face and/or along the outside diameter of the pipe (and the corresponding wall of the coupling) may be unnecessary. In one illustrative example, only the inside diameter of the HDPE pipe and the corresponding wall of the coupling raceway are heated, thus forming only one weld. Again, this may be sufficient even for high-pressure applications as the bond between the ID and the coupling is the primary pressure-bearing bond, and this bond may, by itself, have a greater surface area than existing butt-welded bonds. Whether to completely heat the faces of the pipe and the faces of the raceway, or to only heat one face, or two faces, is a design consideration that may depend on the application use case and the bonding requirements.

To ensure that the HDPE coupling has the proper pressure rating, it may also be reinforced in a sandwich configuration as with the HDPE pipe, but the sandwich material exterior to the raceway coupling. Alternatively, a sleeve around the HDPE coupling may provide the desired pressure rating.

### Selected Examples

The foregoing can be used to build or embody several example implementations, according to the teachings of the present specification. Some example implementations are included here as nonlimiting illustrations of these teachings.

Example 1 is a method of heat welding a length of pipe with a coupling, wherein the coupling and the length of pipe are of a thermoplastic material, the method comprising: preparing a first end of the length of pipe; preparing a first groove of the coupling, wherein the first groove is configured to mechanically interface to an inner diameter (ID) and outer diameter (OD) of the length of pipe; heating the first end and the first groove to a weldable temperature; joining the first end to the first groove; and permitting the first end and the first groove to cool sufficiently long to form a thermoplastic weld.

Example 2 is the method of example 1, wherein the thermoplastic is high-density polyethylene (HDPE).

Example 3 is the method of example 1, wherein the thermoplastic is a thermoplastic that cannot be readily cemented.

Example 4 is the method of example 3, wherein the thermoplastic is selected from the group consisting of polypropylene (PP), polyethylene (PE), high-density polyethylene (HDPE), low-density polyethylene (LDPE), linear low-density polyethylene (LLDPE), polyethylene terephthalate (PET), polytetrafluoroethylene (PTFE), polycarbonate (PC), and polyvinylidene fluoride (PVDF).

Example 5 is the method of example 1, wherein preparing the first end comprises facing the first end.

Example 6 is the method of example 1, wherein preparing the first end comprises abrading the ID and the OD.

Example 7 is the method of example 1, wherein preparing the first end comprises cleaning with a chemical solvent.

Example 8 is the method of example 1, wherein preparing the first groove comprises facing the first groove.

Example 9 is the method of example 1, wherein preparing the first groove comprises abrading the first groove.

Example 10 is the method of example 1, wherein preparing the first groove comprises cleaning the first groove with a chemical solvent.

Example 11 is the method of example 1, wherein heating the first end and the first groove comprises heating the first groove for a time δ, and thereafter heating the first groove and first end together for time t.

Example 12 is the method of example 1, wherein heating the first end and the first groove comprises heating the first groove to different temperatures.

Example 13 is the method of any of examples 1-12, wherein the length of pipe is reinforced.

Example 14 is the method of any of examples 1-12, further comprising applying a reinforcing sleeve to the coupling.

Example 15 is the method of any of examples 1-12, further comprising welding a second end of a second length of pipe to a second groove of the coupling.

Example 16 is an apparatus for heat welding a length of pipe with a coupling, wherein the coupling and the length of pipe are of a thermoplastic material, the apparatus comprising: means for preparing a first end of the length of pipe; means for preparing a first groove of the coupling, wherein the first groove is configured to mechanically interface to an inner diameter (ID) and/or outer diameter (OD) of the length of pipe; means for heating the first end and the first groove to a weldable temperature; and means for joining the first end to the first groove.

Example 17 is the apparatus of example 16, wherein the thermoplastic is high-density polyethylene (HDPE).

Example 18 is the apparatus of example 16, wherein the thermoplastic is a thermoplastic that cannot be readily cemented.

Example 19 is the apparatus of example 18, wherein the thermoplastic is selected from the group consisting of polypropylene (PP), polyethylene (PE), high-density polyethylene (HDPE), low-density polyethylene (LDPE), linear low-density polyethylene (LLDPE), polyethylene terephthalate (PET), polytetrafluoroethylene (PTFE), polycarbonate (PC), and polyvinylidene fluoride (PVDF).

Example 20 is the apparatus of example 16, wherein means for heating are to heat the first end to a first temperature, and the first groove to a second temperature different from the first temperature.

Example 21 is the apparatus of example 16, wherein means for heating are to heat the first groove for a time δ, and thereafter to heat both the first groove and the first end for a time t.

Example 22 is the apparatus of example 16, wherein the means for preparing the first end comprise facing means.

Example 23 is the apparatus of example 16, wherein the means for preparing the first end comprise abrading means.

Example 24 is the apparatus of example 16, wherein the means for preparing the first end comprise a chemical solvent.

Example 25 is the apparatus of example 16, wherein the means for preparing the first groove comprise facing means.

Example 26 is the apparatus of example 16, wherein the means for preparing the first groove comprise abrading means.

Example 27 is the apparatus of example 16, wherein the means for preparing the first groove comprise a chemical solvent.

Example 28 is the apparatus of any of examples 16-25, wherein the length of pipe is reinforced.

Example 29 is the apparatus of any of examples 16-25, further comprising means for applying a reinforcing sleeve to the coupling.

Example 30 is the apparatus of any of examples 16-25, further comprising means for welding a second end of a second length of pipe to a second groove of the coupling.

Example 31 is a thermoplastic coupler, comprising: an outer diameter (OD); an inner diameter (ID); and a raceway disposed between the OD and the ID, wherein the raceway has an outer surface configured to mate to an outer sidewall of a thermoplastic pipe, and an inner surface configured to mate to an inner sidewall of the thermoplastic pipe.

Example 32 is the thermoplastic coupler of example 31, wherein the thermoplastic coupler is reinforced by an external sleeve.

Example 33 is the thermoplastic coupler of example 32, wherein external sleeve is fiberglass or metal.

Example 34 is the thermoplastic coupler of example 31, wherein the thermoplastic coupler is reinforced by an internal sleeve sandwiched between layers of the thermoplastic.

Example 35 is the thermoplastic coupler of example 34, wherein internal sleeve is fiberglass or metal.

Example 36 is the thermoplastic coupler of example 31, wherein the thermoplastic is a thermoplastic that cannot be readily cemented.

Example 37 is the thermoplastic coupler of example 31, wherein the thermoplastic is high-density polyethylene (HDPE).

Example 38 is the thermoplastic coupler of example 31, wherein the thermoplastic is selected from the group consisting of polypropylene (PP), polyethylene (PE), high-density polyethylene (HDPE), low-density polyethylene (LDPE), linear low-density polyethylene (LLDPE), polyethylene terephthalate (PET), polytetrafluoroethylene (PTFE), polycarbonate (PC), and polyvinylidene fluoride (PVDF).

Any of the thermoplastic couplers of examples 31-38 may be straight couplers, tee joint couplers, or elbow joint couplers.

Example 39 is a heater for a welding a thermoplastic pipe to a thermoplastic coupler, comprising a first face and a second face, wherein the heater is to heat the first face and the second face to one or more temperatures sufficient to heat weld the thermoplastic, and wherein the first face has a grooved surface to receive an end of the thermoplastic pipe, and the second face has a protrusion to receive a groove of the thermoplastic coupler.

Example 40 is the heater of example 39, wherein the thermoplastic is a thermoplastic that cannot be readily cemented.

Example 41 is the heater of example 39, wherein the thermoplastic is high-density polyethylene (HDPE).

Example 42 is the heater of example 39, wherein the thermoplastic is selected from the group consisting of polypropylene (PP), polyethylene (PE), high-density polyethylene (HDPE), low-density polyethylene (LDPE), linear low-density polyethylene (LLDPE), polyethylene terephthalate (PET), polytetrafluoroethylene (PTFE), polycarbonate (PC), and polyvinylidene fluoride (PVDF).

Example 43 is the heater of example 39, further comprising an electronic controller to control at least one of heat time and heat temperature.

Example 44 is the heater of example 43, wherein the electronic controller is to heat the first face to a first temperature and the second face to a second temperature, wherein the first temperature and second temperature are different.

Example 45 is the heater of example 43, wherein the electronic controller is to heat the second face for a time δ, and thereafter to heat both the first and second faces for a time t.

Example 46 is the heater of example 39, wherein the first face has a shape and dimensions substantially similar to the thermoplastic coupler.

Example 47 is the heater of example 39, wherein the second face has a shape and dimensions substantially similar to the thermoplastic pipe.

Example 48 is a system for heat welding a thermoplastic pipe to a thermoplastic coupler, wherein the thermoplastic coupler has a groove to fit around and end of the thermoplastic pipe, comprising: a first clamp to receive the end of the thermoplastic pipe; a second clamp to receive the thermoplastic coupler; an insert receiver disposed between the first clamp and second clamp; and a heater to couple with the insert receiver and to heat the end of the thermoplastic pipe and the groove of the thermoplastic coupler to one or more weldable temperatures.

Example 49 is the system of example 48, further comprising a linear actuator to join the groove of the thermoplastic coupler to the end of the thermoplastic pipe.

Example 50 is the system of example 48, further comprising a preparation insert to rotatably prepare the end of the thermoplastic pipe and the groove of the thermoplastic coupler.

Example 51 is the system of example 50, wherein preparing comprises facing.

Example 52 is the system of example 50, wherein preparing comprises abrading.

Example 53 is the system of example 48, wherein the thermoplastic is high-density polyethylene (HDPE).

Example 54 is the system of example 48, wherein the thermoplastic is a thermoplastic that cannot be readily cemented.

Example 55 is the system of example 48, wherein the heater further comprises an electronic controller to control at least one of heat time and heat temperature.

Example 56 is the system of example 55, wherein the electronic controller is to heat a first face to a first temperature and a second face to a second temperature, wherein the first temperature and second temperature are different.

Example 57 is the system of example 55, wherein the electronic controller is to heat a second face for a time δ, and thereafter to heat both a first face and the second face for a time t.

Example 58 is the system of example 48, wherein the heater comprises a face that has a shape and dimensions substantially similar to the thermoplastic coupler.

Example 59 is the system of example 48, wherein a face has that a shape and dimensions substantially similar to the thermoplastic pipe.

Example 60 is the system of example 54, wherein the thermoplastic is selected from the group consisting of polypropylene (PP), polyethylene (PE), high-density polyethylene (HDPE), low-density polyethylene (LDPE), linear low-density polyethylene (LLDPE), polyethylene terephthalate (PET), polytetrafluoroethylene (PTFE), polycarbonate (PC), and polyvinylidene fluoride (PVDF).

Example 61 is the system of any of examples 48-60, wherein thermoplastic pipe is reinforced.

Example 62 is the system of any of examples 48-60, wherein the thermoplastic coupling is reinforced.

Example 63 is the system of any of examples 48-60, wherein the thermoplastic coupling is internally reinforced.

Example 64 is the system of any of examples 48-60, wherein the thermoplastic coupling is reinforced with an external sleeve.

### DETAILED DESCRIPTION OF THE DRAWINGS

A method and apparatus for bonding reinforced HDPE piping will now be described with more particular reference to the attached FIGURES. It should be noted that throughout the FIGURES, certain reference numerals may be repeated to indicate that a particular device or element is referenced multiple times across several FIGURES. In other cases, similar elements may be given new numbers in different FIGURES. Neither of these practices is intended to require a particular relationship between the various embodiments disclosed. In certain examples, a genus or class of elements may be referred to by a reference numeral (“widget 10”), while individual species or examples of the element may be referred to by a hyphenated numeral (“first specific widget 10-1” and “second specific widget 10-2”).

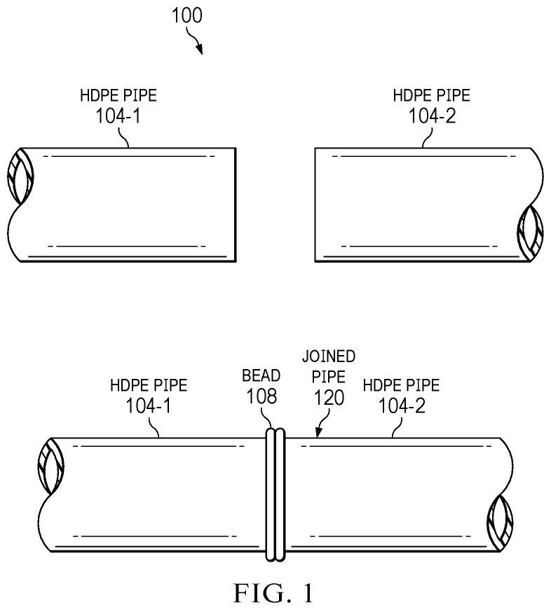

FIG. 1 is a perspective view illustration of HDPE pipes in an HDPE application ecosystem 100. Within HDPE application ecosystem 100, two HDPE pipe lengths are used-namely, pipe 104-1 and pipe 104-2. For use in application ecosystem 100, pipe 104-1 and 104-2 are to be bonded together to form a single pipe length. For example, pipes 104 may be used in a high-pressure application for which HDPE is suitable or preferable.

The composition of pipes 104 may determine which bonding methods are suitable. If the pipes are 100% HDPE, then the two pipes may be appropriately prepared (e.g., with cleaning and facing) and then joined together with a butt weld. After joining, joined pipe 120 includes pipe 104-1 and pipe 104-2. A bead 108 forms at the joint where the two pipes were melted and welded together. If the butt-welding process is performed correctly, then joined pipe 120 may be stronger at the weld of bead 108 than the original pipe. However, if pipes 104 are reinforced, such as with fiberglass, then the strength of the weld at bead 108 may be compromised.

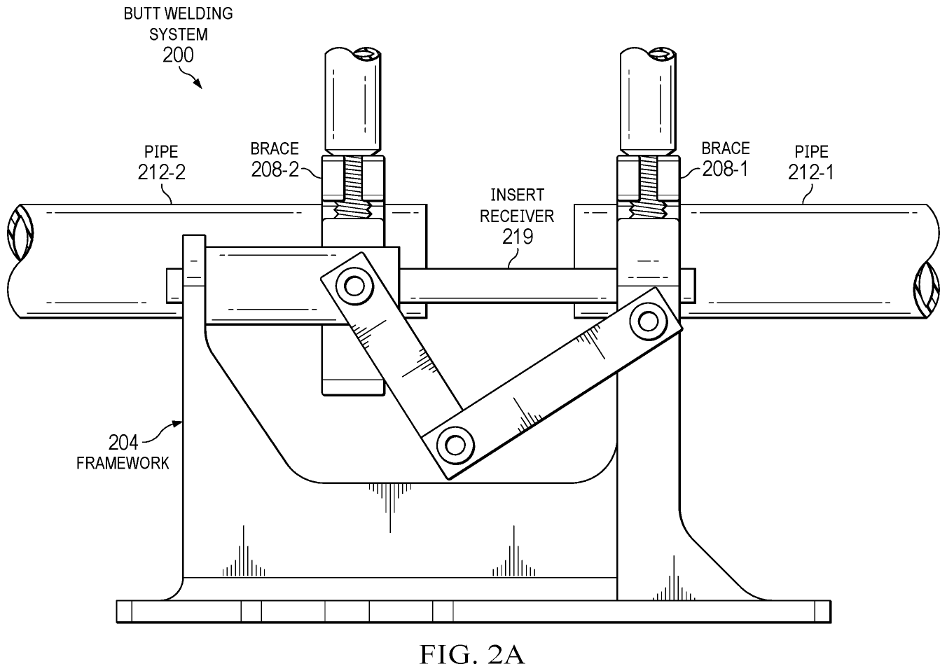

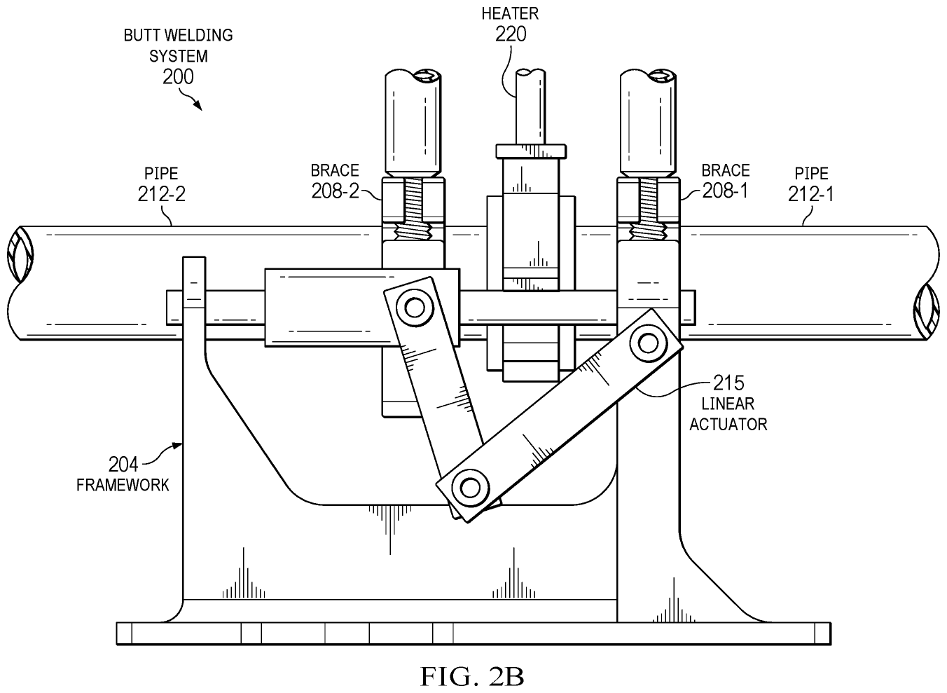

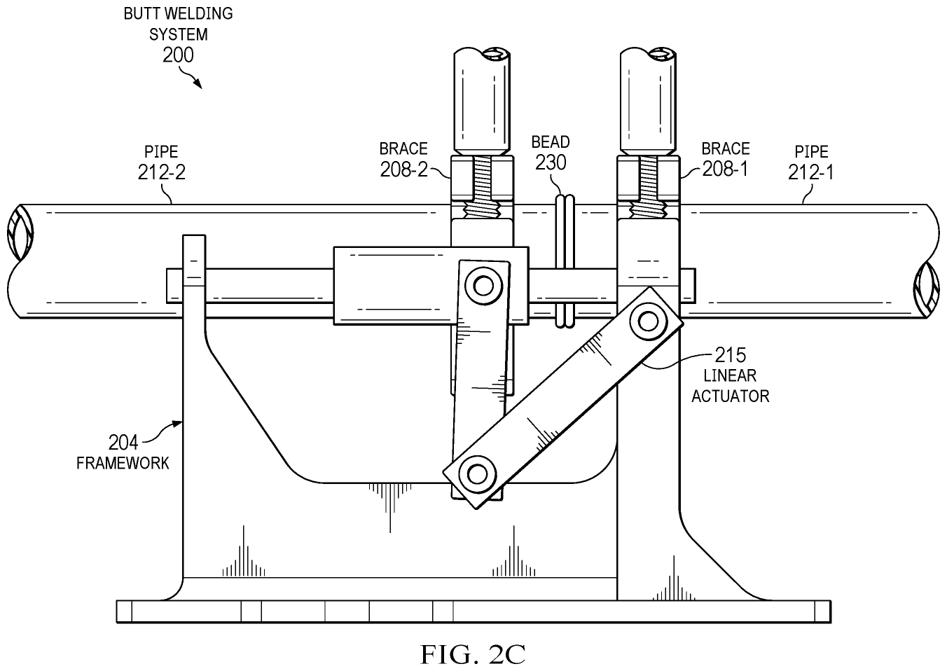

FIGS. 2A, 2B, and 2C illustrate a butt-welding system. Butt welding system 200 is illustrated in the context of an existing standards compliant (e.g., ASTM F2620) butt welding process for 100% HDPE pipe. However, the system as illustrated can be adapted and modified for use with reinforced HDPE pipe as discussed below.

Butt welding system 200 includes a framework 204. In this example, framework 204 is illustrated as a manually operated framework that relies on mechanical force from a human. However, automated electromechanical systems may also be used, and the teachings of the present specification are applicable to both manual and electromechanical systems.

In the example of FIG. 2A, two pipes 212 are loaded into framework 204. Namely, pipe 212-1 is loaded into brace 208-1, while pipe 212-2 is loaded into brace 208-2. A linear actuator 215 is provided to move the pipe segments back and forth, and may provide a mechanical advantage in hand-operated systems, aiding the operator in applying specified pressure.

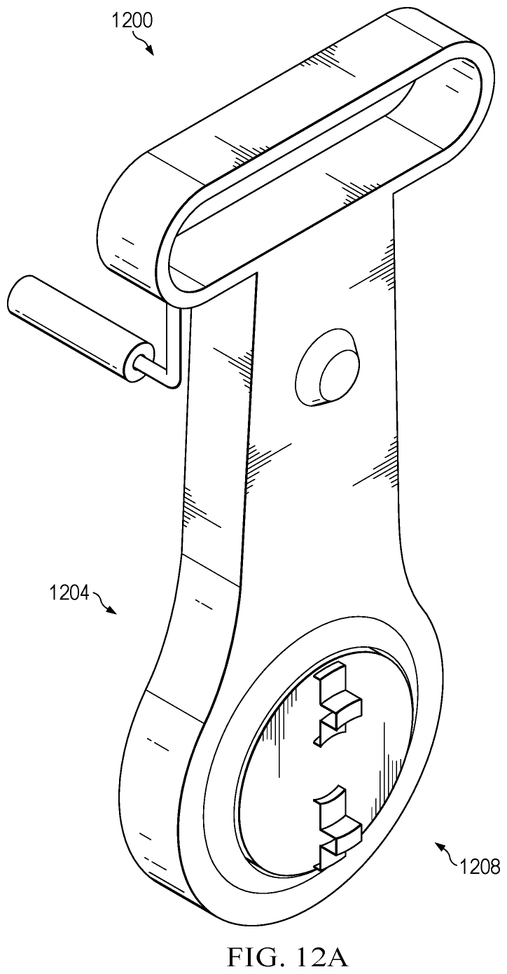

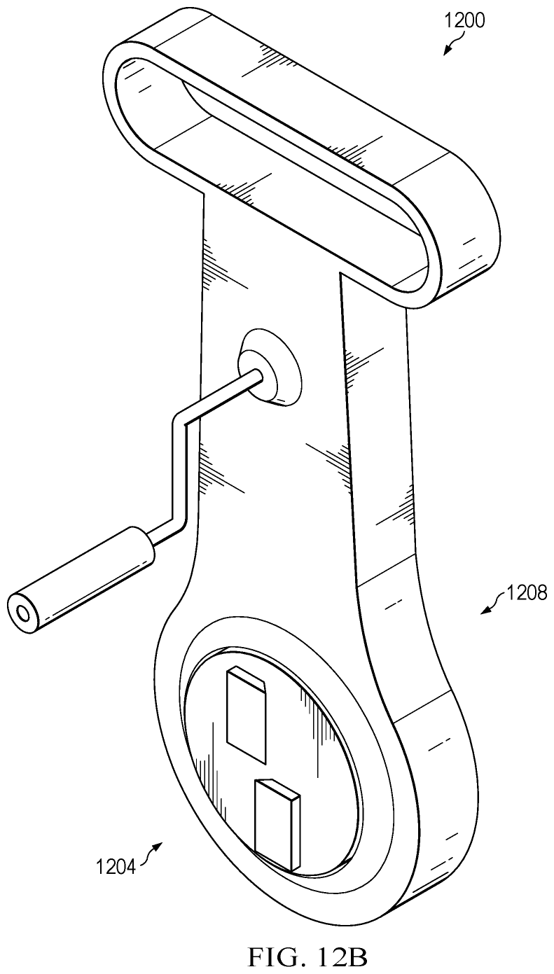

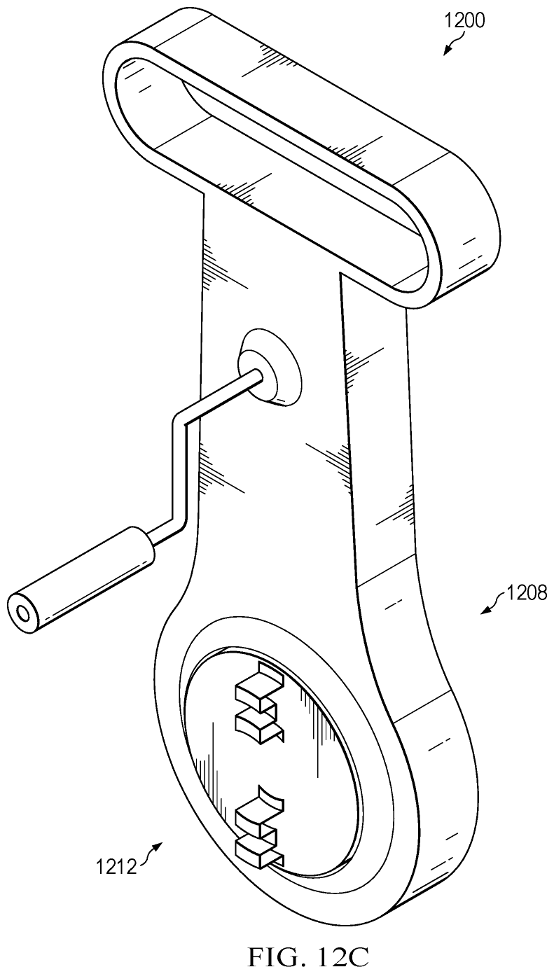

In compliance with F2620, a facer (e.g., a rotary facer, as illustrated in FIG. 12B) is inserted into the assembly, such as at insert receiver 219, which in this example is part of a rail along which the two segments of framework 204 can be actuated. Insert receiver 219 disposes the facer between the two pipes 212, and the pipes are faced by shaving off a small length of material from the end of each pipe. This ensures that the pipe ends are clean and level. The operator may then check to ensure that the two lengths of pipe are parallel and level with one another, and that they have a good fit.

Turning to FIG. 2B, once the pipes have been faced and prepared, a heater 220 is loaded into framework 204 at insert receiver 219, which may include a and slight pressure is applied to force pipes 212-1 and 212-2 against the heated faces of heater 220. Pipes 212-1 and 212-2 are left in contact with the heated faces of heater 220 for a specified time, for example according to the formula specified in ASTM F2620.

After heating the pipe ends for the specified time, framework 204 is manipulated to remove pipes 212-1 and 212-2 from the faces of heater 220.

Turning to FIG. 2C, after the heater has been removed, then framework 204 is actuated to bring pipes 212-1 and 212-2 into contact with one another at a specified pressure. This causes the heated faces of pipes 212 to weld together and form a bond. If all goes well and the butt weld is performed correctly, then a clean, uniform bead 230 forms at the joint between pipe 212-1 and 212-2. After leaving the pipes to set for a time specified in ASTM F2620, the butt weld is complete and pipes 212-1 and 212-2 now form a single length of pipe that can be used in the application with the appropriate pressure rating. Because the joint between the two pipes is at least as strong as (and usually stronger than) the pipes themselves, the butt weld does not compromise the pressure rating of the joint pipe.

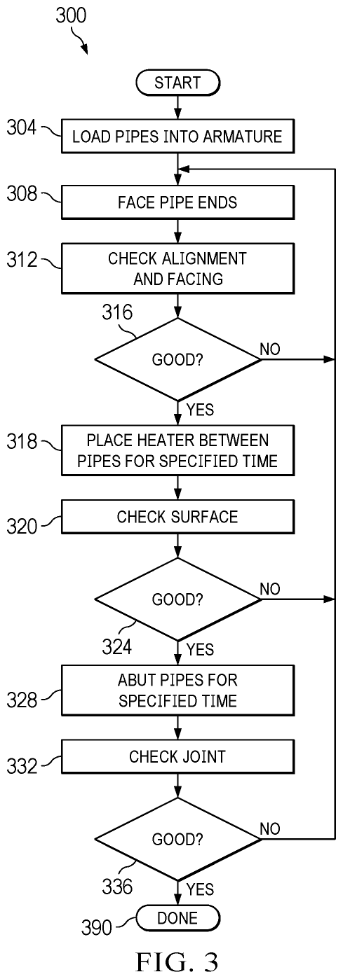

FIG. 3 is a flowchart of a method 300. Method 300 represents selected elements of an existing butt-welding method for 100% HDPE piping. Although this method is applicable to existing use cases, portions of the method are also applicable to, and may be adapted for, the teachings of the present specification.

Within method 300, at block 304 the two lengths of pipe are loaded into the armature of the facing apparatus.

At block 308, a facer is used to face the ends of both pipes. Commonly, the facer is a two-sided apparatus that loads into the armature between the two lengths of pipe and faces both lengths simultaneously. The facer removes material from the end of each pipe and forms a clean, uniform, and level surface on the face of the pipes.

In block 312, the operator may check the alignment and the facing. This is to ensure that the alignment and facing are clean and uniform, that the pipes align level, and that they are parallel to one another. Clean facing and alignment are important aspects of ensuring that a good butt weld is formed.

In decision block 316, if the alignment and facing are not to standards, then the operator may return to block 308 and start again.

If the alignment and facing are good, then in block 318 the operator may remove the facer from the armature and load the heater into the armature (e.g., at insert receiver 219 of FIG. 2). The heater may already be pre-heated to a specified temperature for the application, which may depend on the thickness of the HDPE pipe walls. The operator may apply specified pressure to bring the two pipe faces into contact with the two faces of the heater for the specified time. Then the pressure is dropped to zero so that a melted pool of material can form (called “heat soak”). After the specified time, the operator may manipulate the armature to move the two faces away from the heater.

In block 320, while being conscious of time requirements so that the faces do not cool too much, the operator visually inspects the surface of the heated pipe faces. They should be clean, and they should not have acquired any concave or convex features from heating. Impurities or surface irregularities can compromise the strength of the bond.

In decision block 324, if the heated faces do not have good, clean, level, and uniform heated characteristics, then the operator may wait for the heated faces to cool. The operator then returns to block 308 and starts the process over, including facing off the heated end.

If the two faces do have good, clean, uniform surfaces after heating, then in block 328 the operator operates the armature to abut the pipes for the specified time to allow a complete weld to form.

In block 332, the operator checks to ensure that a satisfactory bond is formed, and that a good, clean, uniform bead has formed around the joint where the two pipes abut.

In decision block 336, if a good, uniform bead has not formed around the joint or the bead is not clean, then the operator cuts the lengths of pipe to remove the unsatisfactory weld, then returns to block 308 and starts the process again.

If a good, clean, uniform bead has formed at the joint, then the two pipes have been properly butt welded, and in block 390 the method is done.

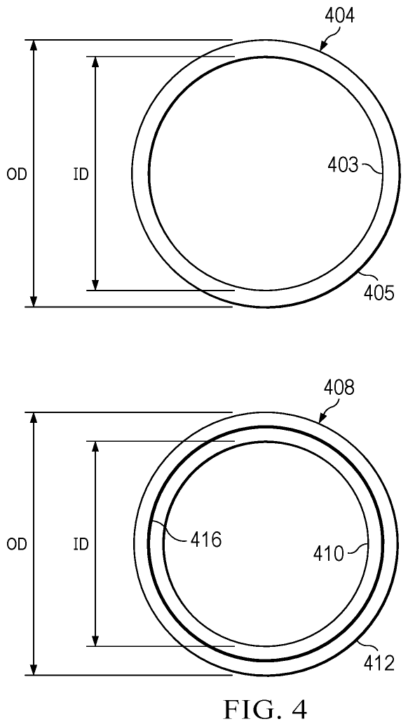

FIG. 4 is a cutaway front view of selected aspects of an HDPE pipe. Pipe 404 is a 100% HDPE pipe having an outer diameter (ID) 405 and an inner diameter (ID) 403. Commonly, HDPE pipes are OD controlled. For example, a nominal “8 inch” pipe may have a specified OD of 8.625 inches. The ID may depend on the pressure rating of the pipe, e.g., a smaller ID forms a thicker pipe wall with a greater pressure rating, but may also have a smaller volume capacity. A standard dimension ratio (SDR) may be used to calculate ID from OD (e.g., ID=). Fluid may pass through the inner diameter 403 up to a specified pressure rating, according to the ID.

As described above, 100% HDPE pipe 404 may be suitable for many applications. However, it has become desirable to use HDPE piping in applications where the pressure requirements exceed the pressure rating of many 100% HDPE pipes, such as pipe 404.

Pipe 408 illustrates another HDPE pipe. Pipe 408 also has an ID 410 and an OD 412. As in the example above, fluid may pass through the pipe within ID 410. However, in this case HDPE pipe 408 is reinforced with a reinforcing material 416 that is sandwiched between layers of HDPE. Reinforcing material 416 may be, for example, fiberglass, metal, composite, advanced materials such as carbon nano fibers, or others. Advantageously, the inclusion of reinforcing material 416 may substantially increase the pressure rating of HDPE pipe 408 as compared to a similarly sized pipe 404 of 100% HDPE construction. However, the reinforcing material may melt, warp, deform, or otherwise contaminate the butt weld if known butt-welding methods are used. Furthermore, even if the properties of reinforcing material 416 are such that it does not melt, warp, or deform during the heating process, its presence may nevertheless reduce the contact surface area between ends of the HDPE pipe, thus compromising the pressure rating of the bond.

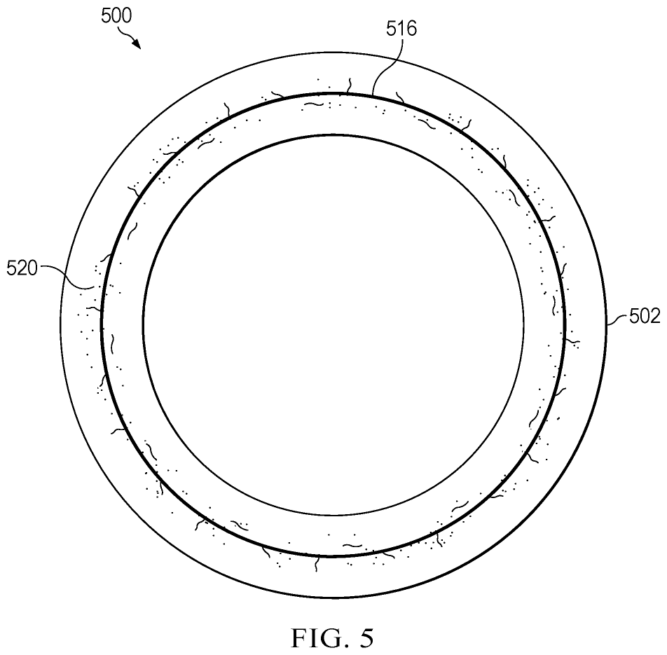

FIG. 5 is a cutaway front view 500 of a reinforced HDPE pipe. FIG. 5 illustrates certain challenges with the use of reinforced HDPE piping. In this example, HDPE pipe 502 includes a reinforcing material 516. This increases the pressure rating of HDPE pipe 502 relative to a similarly sized pipe of pure HDPE construction.

However, if a butt weld is attempted using HDPE pipe 502, then during the heating process reinforcing material 516 may also become heated and may disperse. This forms contamination 520 within the face of HDPE pipe 502. Because the abutting pipe would also have reinforcing material 516, it would also form similar contamination 520. Thus, if the two pipes are butt welded, contamination 520 will compromise the strength of the butt weld and will therefore compromise the pressure rating of the joined pipe.

In some cases, this potential for contamination may make reinforced HDPE pipe 502 unsuitable for the standards compliant butt-welding process. Nevertheless, the increased pressure rating of pipe 502 may make its use desirable within high-pressure applications, including, for example, in oil and gas applications. It is therefore desirable to provide a method and apparatus of joining two reinforced HDPE pipes without compromising the integrity of the bond with contamination 520.

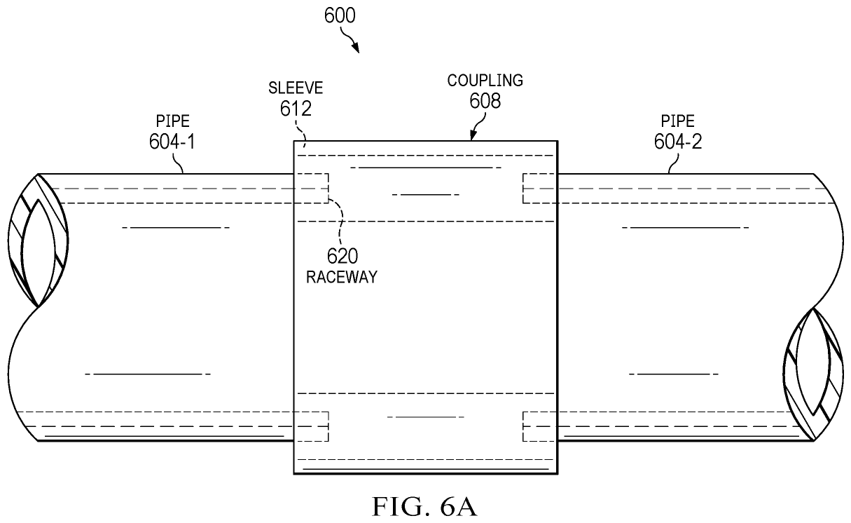

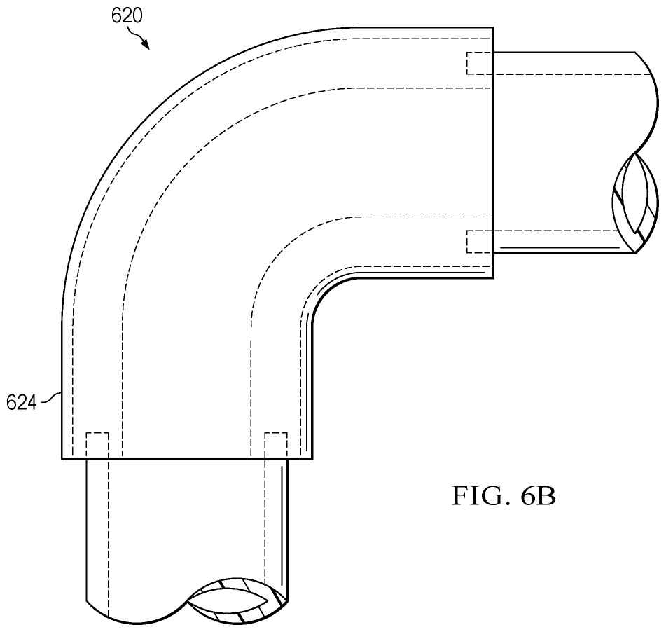

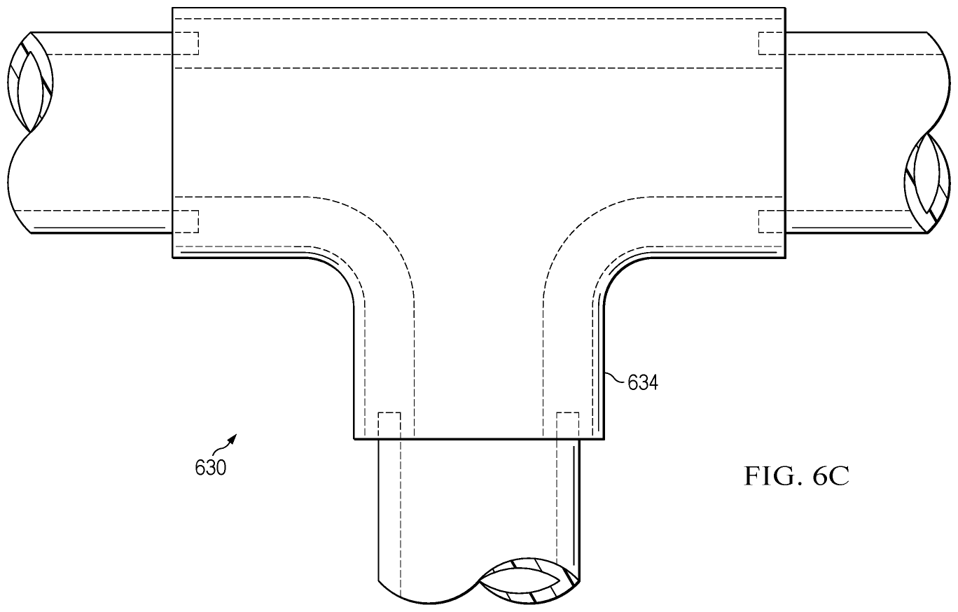

FIG. 6A is a perspective view of an HDPE bonded system 600. HDPE bonded system 600 is useful in the case of reinforced HDPE pipes, which in some cases may not be suitable for traditional butt welding. System 600 may also be used in connection with unreinforced HDPE pipes, such as in cases where butt welding is impractical or not desirable, or simply as an alternative to butt welding. HDPE bonded system 600 may also be used to form a junction between reinforced and unreinforced HDPE pipes.

In the example of FIG. 6A, HDPE bonded system 600 includes a straight coupling or coupler (the terms “coupling” and “coupler” are often used interchangeably in the industry, with no well-defined difference between the two; for purposes of this specification, the terms are treated as synonymous). In system 600, a first reinforced HDPE pipe 604-1 is joined to a second reinforced HDPE pipe 604-2. Because these pipes are reinforced, such as with an internal fiberglass layer, traditional butt welding may be impractical for bonding HDPE pipe 604-1 to HDPE pipe 604-2. The internal fiberglass may introduce contamination into the weld joint, which may result in a noncompliant bond that does not provide a sufficient pressure rating. In this example, a coupling 612 is provided to join HDPE pipe 604-1 to HDPE pipe 604-2. Coupling 612 includes an internal raceway 620 that is mechanically configured to receive the rims of respective pipes 604, and that will also snugly contact the ID and OD of the pipe along the length of coupling 612. Coupling 612 may also have disposed around it a sleeve 608, which further reinforces the coupling. This may help to ensure that the coupling-which may be manufactured from HDPE-meets the required pressure rating for the application. Sleeve 608 may be a metal sleeve, fiberglass, composite, nano material, or other material that reinforces coupling 612. Sleeve 608 may be bonded to coupling 612, such as with cement, epoxy, or mechanical means. Gluing may be appropriate in this application because the bond is not pressure-bearing.

An advantage of manufacturing coupling 612 from 100% HDPE is that this may help to ensure a good bond between coupling 612 and the respective pipes 604. Because the reinforced pipes may have an internal layer of reinforcing material in a sandwich configuration, the ID and OD may be 100% HDPE. Thus, if coupling 612 is also 100% HDPE, then a good weld joint can form between coupling 612 and the walls of respective pipes 604.

FIG. 6B illustrates another bonded system 620. In this example, coupler 624 is an elbow joint coupler.

FIG. 6C illustrates another bonded system 630. In this example, coupler 634 is a tee joint coupler.

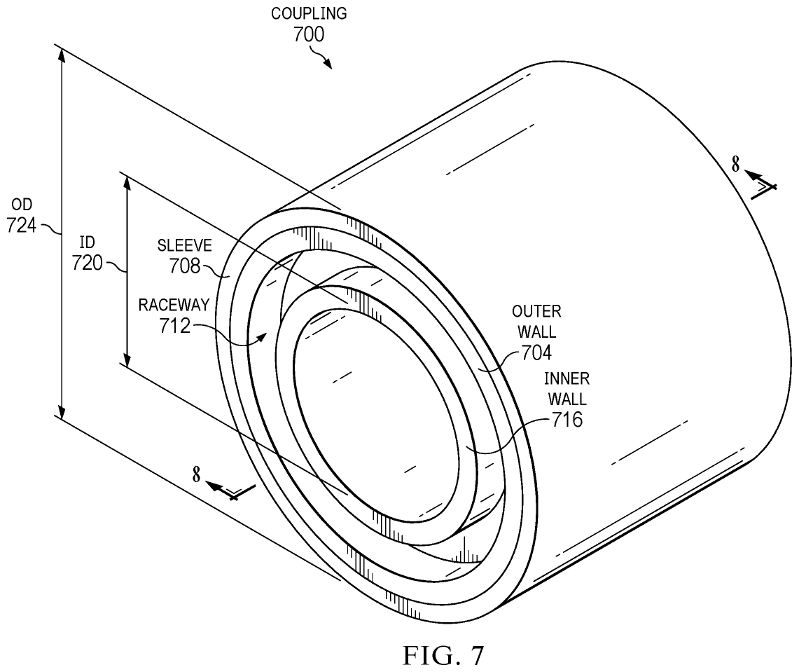

Couplers 608, 624, and 634 may, in some examples, be reinforced with an external sleeve or casing (see, e.g., sleeve 708 of FIG. 7). The sleeve may be attached mechanically or with a suitable cement during the coupling process, or may be permanently affixed as part of the original manufacture of the coupler.

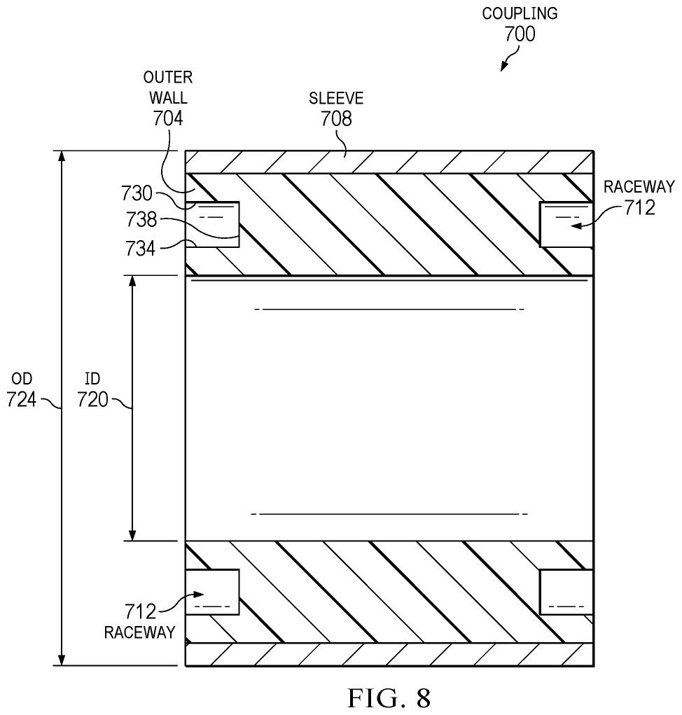

FIG. 7 is a perspective view of a coupling 700. FIG. 8 is a side view of coupling 700, cutaway as illustrated. FIGS. 7 and 8 use common numbering to refer to same elements. Coupling 700 is surrounded by a sleeve 708 which may, for example, metal, fiberglass, or some other material. Sleeve 708 may be bonded to coupling 700 with an adhesive, such as a cyanoacrylate, a two-part epoxy, a structural acrylic, a polyurethane adhesive, or mechanical means. The adhesive need not necessarily be rated for high pressure, but may only need to be sufficient to securely hold sleeve 708 in place around coupling 700. This provides the appropriate high-pressure reinforcement. Coupling 700 may also include an outer wall 704, which may be manufactured from 100% HDPE. Inner wall 716 may also be manufactured from 100% HDPE. Between outer wall and inner wall 716 is a raceway 712. Raceway 712 forms an indentation or groove with dimensions controlled to receive both the inner diameter and outer diameter of a selected HDPE pipe.

Coupling 700 includes an ID 720. The fluid or gas that the pipe carries flows through ID 720. Coupling 700 also includes an OD 724, which forms the outer wall. Disposed between ID 720 and OD 724 is a raceway 712.

As illustrated in FIG. 6, the HDPE pipe may fit snugly into raceway 712. In particular, outer wall 730 of raceway 712 may wrap around the OD of an HDPE pipe, while inner wall 734 of raceway 712 wraps around the ID of the HDPE pipe. Face 738 of raceway 712 abuts a facing edge of the HDPE pipe.

To bond an HDPE pipe to coupling 700, the end of the HDPE pipe may be faced as discussed above. This ensures that the face is clean and level. Furthermore, the inside diameter and outside diameter of the HDPE pipe may be faced, such as by shaving a small amount of material off each side. Alternatively, the surfaces may be cleaned without removing substantial material, such as with a scraping or abrading device, or with a chemical cleaning agent. Suitable chemical cleaning agents may include acetone, PVC cleaner, or even mild soap and water.

Similarly, raceway 712 may be cleaned or faced as appropriate. If raceway 712 and/or the pipe inner and outer surfaces are to be faced, then the dimensions of raceway 712 should be adjusted to allow for a slight difference in thickness when the facing occurs. If the surfaces are merely to be scraped and/or cleaned, then the dimensions of raceway 712 may be slightly larger than the specified dimensions of the HDPE pipe inner diameter and outer diameter to snugly receive the fitting. For example, in common practice, a fitting may be approximately 0.05% to 0.1% percent larger than the element it couples to.

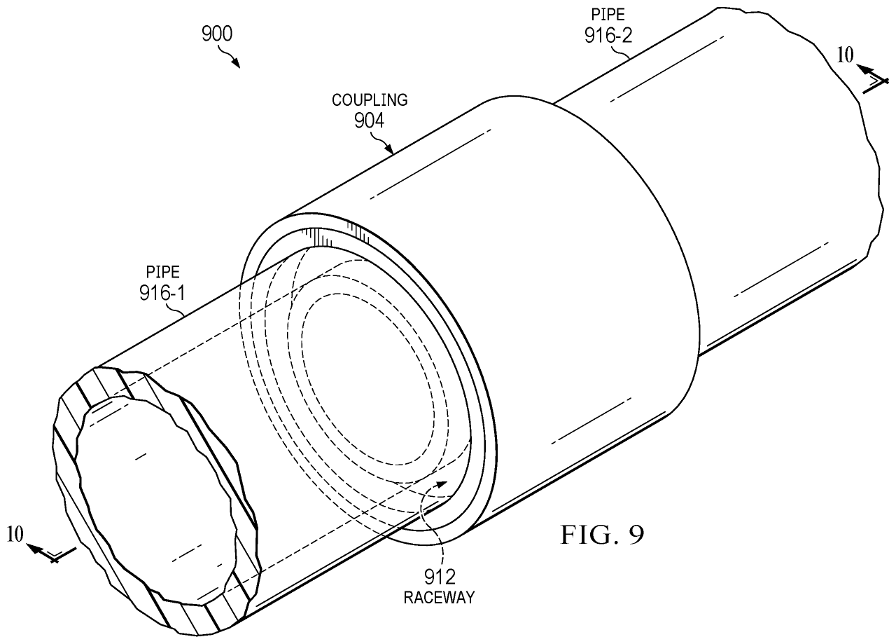

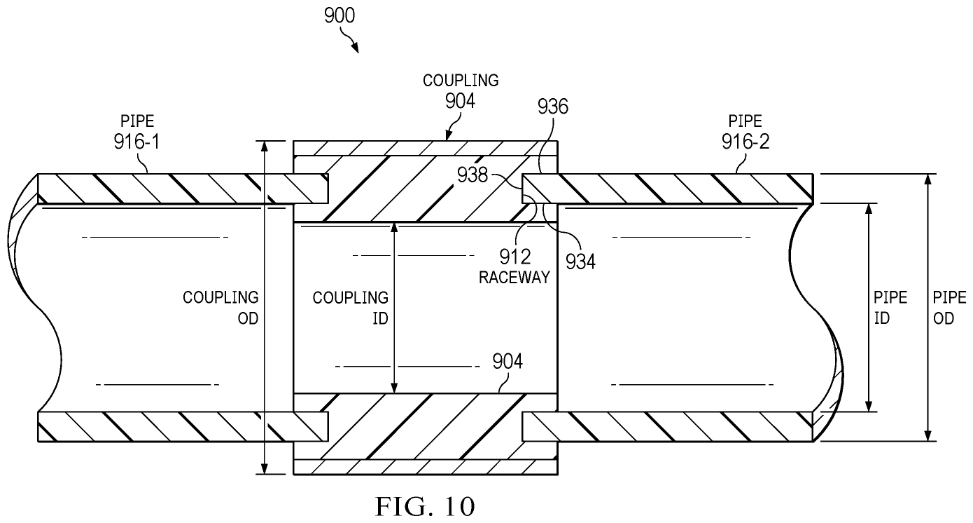

FIG. 9 is a perspective view illustration of a pair of pipes bonded to a coupling. FIG. 10 is a cutaway view of the bonded pipes of FIG. 9. FIGS. 9 and 10 use common numbering for same elements. In this example, HDPE pipes 916-1 and 916-2 are bonded to a coupling 904. Coupling 904 may include the features illustrated in FIGS. 7 and 8, as appropriate.

Pipes 916-1 and 916-2 are inserted into respective raceways 912 of coupling 904. This can be better seen in FIG. 10. Pipes 916-1 and 916-2 have inner diameters and outer diameters, with the pipes inserted snugly into raceway 912 of coupling 904. Coupling 904 has a coupling inner diameter which allows fluid to pass through in operation. To secure pipes 916-1 and 916-2 to coupling 904, a bonding operation similar to the bonding of butt welding may be performed. In particular, a novel heater may be configured to wrap around the edges of pipes 916 so that it heats not only the abutting face, but also a portion of the inner and outer surfaces of the pipe. This novel heater may include a shape and dimensions similar to coupling 904. Similarly, an opposing face of the novel heater may include a face with a shape and dimensions similar to a pipe 916, so heat raceway 912. The length of surface heated on the pipes may be configured to substantially match the depth of raceway 912, which may be, by way of illustrative example, ½ inch, ¾ inch, 1 inch, 1.5 inches, 2 inches, 2.5 inches, 3 inches, 4 inches, 5 inches, 6 inches, or another appropriate size. For very large HDPE pipes, the length of surface heated may be substantially higher, such as 12 inches or more. The surfaces of raceway 912 may also simultaneously be heated. In these cases, the heating times may need to be adjusted from those specified for HDPE butt welding. In particular, because a larger surface area is being heated, additional time may be necessary to ensure uniform heating of the entire surface. Furthermore, because the material thicknesses between the coupling and the pipe are not the same, in some cases it may be necessary to heat them for different times. Generally, the coupling may have thicker material and may need to be heated longer. In those cases, the coupling may be heated for up to the time difference between the two heating requirements, and then the pipe may be applied to the heater for the remainder of the heating time.

Once both the pipe surfaces and the raceway have been heated, they may be joined using an apparatus or armature similar to that used for butt welding, with the coupling inserted into one brace and the pipe into the other. This bonds the two surfaces together, and pressure may be maintained for a sufficient time. Once sufficient time has elapsed to form a good weld between pipe 916 and raceway 912, pressure may be released and a strong weld is formed.

Notably, because pipe 916 may be reinforced, there may be contamination between the butt of pipe 916 and the abutting face of raceway 912. However, this contamination is not necessarily problematic, because the pressure-bearing weld is formed at face 934, between the inner diameter of pipe 916 and the inner wall of raceway 912. Additional bonding at face 938 and at outer wall 936 may be considered supplemental. This additional bonding may help to secure the coupling 904 to pipe 916 but is not necessarily pressure bearing. In some cases, welding at face 938 and wall 936 may not be necessary. In those applications, only the inner wall of raceway 912 and the inner diameter of pipe 916 need to be heated. This may simplify manufacturing of a heating element, and may also provide a simpler process. This may still form a solid, pressure-bearing bond between pipe 916 and coupling 904. In other embodiments, only faces 934 and 936 may be heat welded. In another embodiment, only faces 934 and 938 may be heat welded. Appropriate heating elements may be provided for each of these use cases.

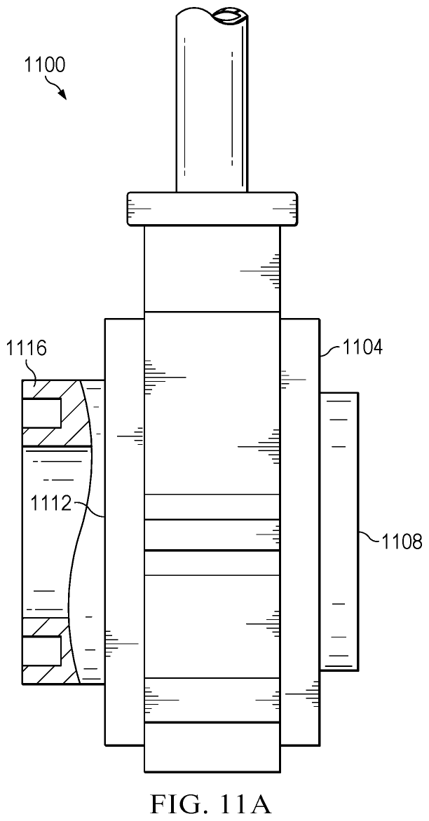

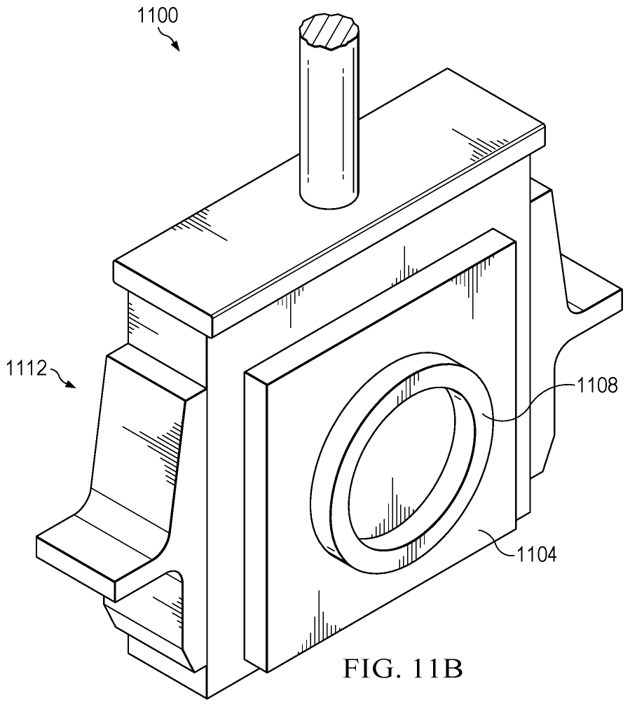

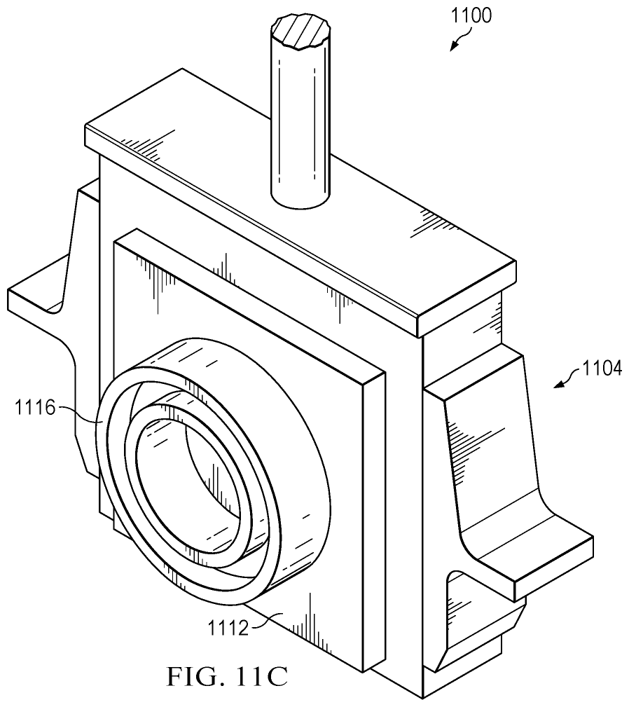

FIGS. 11A, 11B, and 11C illustrate an embodiment of a heating element. In existing systems, a heater similar to heater 1100 has flat surfaces on both sides to uniformly heat the flat butts of two HDPE pipes simultaneously. HDPE heater 1100 of FIG. 11A has faces that are shaped to receive a coupling and a pipe, and otherwise may be similar to existing heaters. HDPE heater 100 may pre-heat to a specified temperature, and may include user controls to select the specified temperature or temperatures for heating. Notably, because the pipe and the coupling have different thicknesses and (at least partially) different compositions because of the reinforcing material sandwiched within the pipe, the heating times and heating temperatures may be different for the two sides. Thus, heater 1100 may have independent temperature controls for its two sides, and the attendant method may specify different heating times. In this example, heater 1100 includes shaped faces 1104 and 1112, with protruding elements 1108 and 1116.

As illustrated in FIG. 11B, protrusion 1108 may be configured to fit within a raceway of a coupling. Protrusion 1108 may have a shape and dimensions similar to or the same as an HDPE pipe, and thus may fit within the raceway while heating (though in some embodiments, it may fit somewhat more loosely than pipe to coupling interface). The height of protrusion 1108 may be selected to coincide with the desired contact surface area between the coupling and the pipe. This illustrates an advantage of the present system and method in terms of adaptability. While existing methods, like ASTM F2620, are inherently limited to the contact area of the abutting faces of the two pipe segments, the present method does not have the same limitation. If a contact surface area is found to be impractical or insufficient for a given application, then the contact surface area can be increased or decreased as necessary. It is anticipated that the desirable contact surface area may generally vary directly with the pipe diameter and/or with the pressure requirements of the application. In general, the greater the contact surface area, the stronger the bond.

FIG. 11C illustrates an opposite side of heater 1100, which may be configured to fit around the HDPE pipe that is to be inserted within the raceway. In FIG. 11C, protrusion 1116 may have a shape and dimensions similar to the raceway, and may be configured to fit around the HDPE pipe (though it may fit somewhat more loosely than the coupling). The size and shape of protrusion 1116 may be selected to generally correspond to the desired contact surface area, and the size of the coupling.

In cases where only part of the pipe and raceway are to be heated (e.g., where face 934 of FIG. 10 is the only face to be welded), then the protrusions may be simplified. The protrusions may be shaped to go around only those parts that are to be heated, or alternatively, heating elements may be disposed to heat only part of the surface of heater 1100, to coincide with those parts of the pipe to be heated.

To bond the second pipe segment, the heater may be reversed, or the first pipe segment (now bonded to the coupling) may be loaded into the opposing brace, and the new pipe segment into the brace that previously held the first pipe. Alternatively, two heaters may be used with opposing orientations, so that both sides of the coupling can be heated at once, along with both pipe segments.

FIGS. 12A and 12B illustrate configurations of a preparation insert 1200. Preparation insert 1200 may be used to prepare the coupler and the pipe end for thermal welding. Various methods of preparation are possible. In existing HDPE welding systems, the only contact surface is on the abutting faces of the two lengths of pipes. Because of this limited contact surface, existing systems require an absolutely clean surface with absolutely flat, parallel, and level contact surface. A facer is therefore a standards-driven requirement for preparing HDPE pipes for butt welding.

In certain embodiments of the present specification, the requirements for preparing both the pipe and the coupler may be less stringent. Because the contact surface is greater and the contact less precarious, irregularities and/or impurities may be more tolerable, particularly in the non-pressure-bearing surfaces. This includes the butt of the pipe and the bottom surface of the groove. Thus, in some embodiments, simpler preparation procedures may be suitable. Furthermore, with internally reinforced pipes, even a clean, new, parallel contact surface on the butt end of the pipe may not be sufficient to form an adequate bond on its own. Because the reinforcing material can melt and contaminate the thermoplastic, material corruption can lead to a compromised bond. Contamination at this joint may be expected and tolerable because in the present teachings, that joint need not be pressure bearing.

Embodiments of the present specification form a bond not just on the butt end of the pipe, but also along the inner face of the pipe end, and optionally also along the outer face of the pipe end. This greater contact surface may provide more tolerance for impurities or irregularities. So in certain embodiments, completely facing the coupler and the pipe end may not be necessary. Rather, preparation may include cleaning the surfaces, such as by abrading them with a scraper, cleaning them with a chemical solvent, or even just wiping off surface contaminants.

In these figures, three face options are shown for preparation insert 1200. Preparation insert 1200 may be made with only two selected faces, or it may be made with an interchangeable face mechanism so that users can switch out the various faces. Furthermore, in some examples, a facer or preparation insert may not be necessary.

Preparation insert 1200 of FIG. 12A may have one face 1204 that is similar to existing facers. Face 1204 may be configured with blades to shave off part of a face of an HDPE pipe. This may still be desirable, or evolving standards may continue to require facing to provide the best contact surface possible at the butt end. However, facing may not be necessary in all embodiments, and in some embodiments may be insufficient to prepare the inner wall and outer wall of both the pipe and the coupling.

Face 1208 of FIG. 12B may be configured to fit within the raceway or groove of a coupling. Like the corresponding heater, face 1208 may have a shape (or partial shape) and dimensions substantially similar to the pipe walls. Depending on the demands of the use case, the blades may be sharpened to face off material, or may be blunt to abrade the surface.

Face 1212 of FIG. 12C may be configured to prepare the inner and outer wall of the pipe end. Like the corresponding heater, face 1212 may have a shape (or partial shape) and dimensions substantially similar to the coupler. Depending on the demands of the use case, the blades may be sharpened to face off material, or may be blunt to abrade the surface.

As mentioned, face 1208 and face 1212 may be sharpened (to face off material), or unsharpened to abrade the surfaces. Facing these surfaces may not be necessary or desirable. By definition, facing removes a certain amount of material to reveal fresh thermoplastic material underneath the surface. When working with a length of pipe, facing is straightforward, and the removed length of pipe is generally inconsequential compared to the length of the pipe segment. However, because the coupler of the present specification is designed to snugly fit around the inside and outside faces of the pipe end, facing material off the ID and OD of both the pipe and coupler may result in inadequate contact and an inadequate bond. If faces 1208 and/or 1212 are provisioned with cutting blades that remove substantial material, the coupler may be designed with extra thickness of the raceway or groove, to ensure that an adequate bond is formed when some material has been removed from one or both of the coupler and the pipe.

Such a solution may introduce configuration and quality control complexities, and in some cases may be unnecessary. Because the contact surface can be much greater than in existing butt welding systems, it may be adequate to simply clean the contact surfaces instead of facing them. In an example, faces 1208 and 1212 may be unsharpened scrapers that abrade surface contaminants from the faces, without removing substantial thermoplastic material. In another example, instead of or in addition to facers or scrapers, preparation of the contact surfaces may include using a chemical solvent. For example, common isopropyl rubbing alcohol may be adequate to clean the surfaces. Particularly, one of the reasons for facing pipes in the current standards is to provide a parallel surface on the abutting ends, as well as cleaning those ends to near absolute purity. Because the teachings herein do not require joining pipes at abutting ends, the provision of parallel faces via facing may be unnecessary. Some nontrivial deviation from parallel may be tolerable between the coupler and the butt of the pipe. In fact, because the abutting face joint may be optional and non-pressure-bearing, even substantial irregularities may be tolerable, so long as a sufficient weld joint is formed between the inner wall of the raceway and the ID of the pipe. Thus, some embodiments may forego facing of the pipe ends.

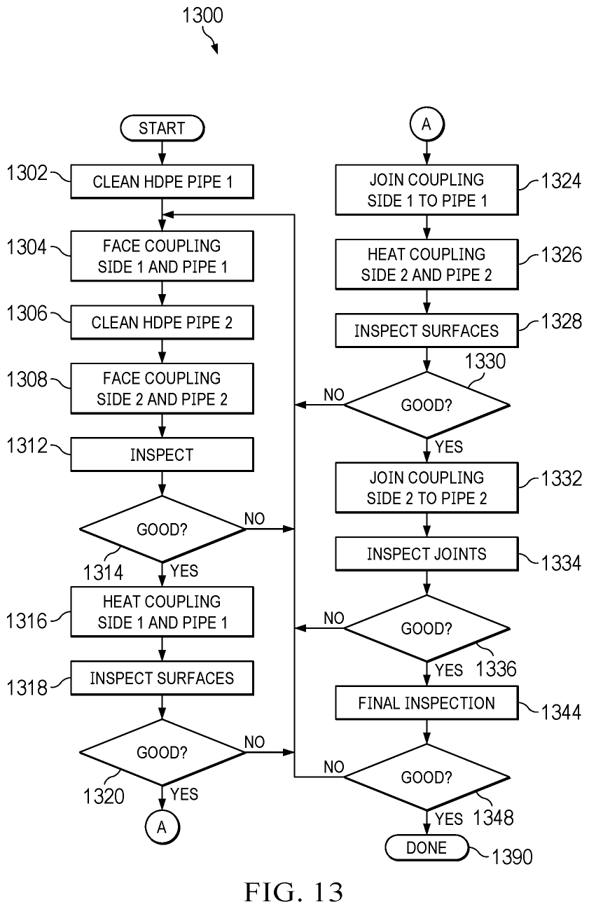

FIG. 13 is a flowchart of a method 1300 of joining two HDPE pipes with an HDPE coupling. The order of operations illustrated here is provided as an illustration only and, where logical, some operations may be performed in a different order. For example, this illustrates a method of preparing and welding the two pipes to the coupler in a substantially parallel order of operations. The method may also be serialized between the two pipes.

In block 1302, the operator may first clean HDPE pipe 1. This removes debris, contaminations, and other material from the working surfaces of HDPE pipe 1.

In block 1304, the operator may face one side of the coupling (coupling side 1) and the face of pipe 1. Facing of the pipe and/or coupling is provided as an illustrative example. In other embodiments, the raceway may simply be scraped or cleaned to provide a good working surface, particularly at the pressure-bearing joint between the ID of the pipe and the inner surface of the coupling raceway.

In block 1306, the operator cleans HDPE pipe 2. This may include cleaning or facing, as appropriate.

In block 1308, the operator optionally faces coupling side 2 and pipe 2. As before, facing of the coupling is provided as an example, and may instead be replaced with cleaning or scraping.

In block 1312, the operator inspects the pipes and the couplings to ensure that the cleaning was successful.

In decision block 1314, if the couplings do not pass inspection, then the operator returns to block 1304 and repeats the cleaning and/or facing.

If the cleaning and facing are successful, then in block 1316, the operator may heat coupling side 1 and pipe 1. In some cases, because the coupling and the pipe have different thicknesses, it may be necessary to heat them for different amounts of time. For example, the coupling may need to be heated longer than the pipe. If that is the case, then heating of the coupling may begin first, and heating of the pipe may commence thereafter. For example, if the method calls for heating the pipe for time t, and heating the coupler for time t+δ, then the coupler may first be heated for time δ, and then both the coupler and the pipe may continue to be heated for time t.

In some cases, a heater may be programmed to provide an appropriate delay between heating the pipe and heating the coupling. However, if it is necessary to preheat the heater, then the coupling may first be applied to the heater and then to the sometime thereafter, so that they finish at approximately the same time. For example, if the coupler is to be heated for time t+δ, and the pipe is to be heated for time t, then an electronic controller for the heater may first heat the surface for the coupler for time δ, and thereafter bring the surface for the pipe up to its specified temperature. Once the surface for the pipe has been pre-heated to its specified temperature, the heater may heat both surfaces for time t. Alternatively, the controller could pre-heat both sides to their specified temperatures (which may be different), and an operator could apply the pipe to its surface after time δ. In cases where the heat temperatures are different, each side may have a separate heating element, and a thermal insulator may be disposed between the two surfaces to prevent heat from leaking from the hotter side to the cooler side. Alternatively, other means could be used to regulate the temperature, such as circulating heat from one side to the other.

In block 1318, the operator inspects the surfaces to ensure that a good, uniform heating has occurred, particularly on the inner wall of the coupling raceway and on the inner diameter wall of the HDPE pipe, which is the pressure-bearing joint.

In decision block 1320, if the coupling and pipe do not pass inspection, then control returns to block 1304 and the process begins again. Note that in some cases, heating the coupling may change its form and shape, and thus heating a coupling more than once may not be practical. In that case, the coupling may need to be discarded and replaced with a new coupling. Advantageously, if a reinforcing sleeve is separate from the coupling, only the coupling itself needs to be discarded and not the entire assembly.

If the surfaces pass inspection, then in block 1324, the user joins coupling side 1 to pipe 1. This may include applying pressure for a specified time until a complete weld is formed.

Once side 1 of the coupling has been bonded to pipe 1, then in block 1326, the operator may reverse the heater, and may now heat coupling side 2 and pipe 2.

After heating the coupling and the pipe, in block 1328, the operator may inspect the surfaces to ensure a clean, uniform heating has occurred.

In block 1330, if the heating failed, then the operator may return to block 1304 and start over. This may require cutting the coupling off of pipe 1 and starting over with a new coupling.

If the surfaces pass inspection, then in block 1332, the operator joins coupling side 2 to pipe 2 by applying appropriate pressure. The time for applying pressure to form a good weld may be similar between the two pipes and the two sides of the coupling. For both pipes and couplings, a framework similar to the framework illustrated in FIGS. 2A, 2B, and 2C may be used.

In block 1334, the operator inspects the joints with the coupling to ensure that they are secure and well-bonded.

In decision block 1336, if the coupling does not pass inspection, then the operator returns to block 1304 and starts over. This may require cutting the pipe away from both sides of the coupling and starting with a new coupling.

In some embodiments where a reinforcing sleeve is not already built into the coupling, it may be desirable to manually attach a coupling.

In block 1344, the operator performs a final inspection of all joints and welds.

In decision block 1348, if the joint does not pass final inspection, then the operator returns to block 1304 and starts over. If the coupling does pass final inspection, then in block 1390, the method is done.

The order of operations illustrated herein is intended to illustrate which operations are performed, without necessarily requiring a particular order. For example, it may be desirable to clean and face the second pipe and coupling (blocks 1306 and 1308) after completing the bonding of the first pipe to the coupling. This may help to avoid contamination of the second pipe and the second end of the coupling while the first pipe is being bonded. Other orders of operations may also be adopted for various purposes.

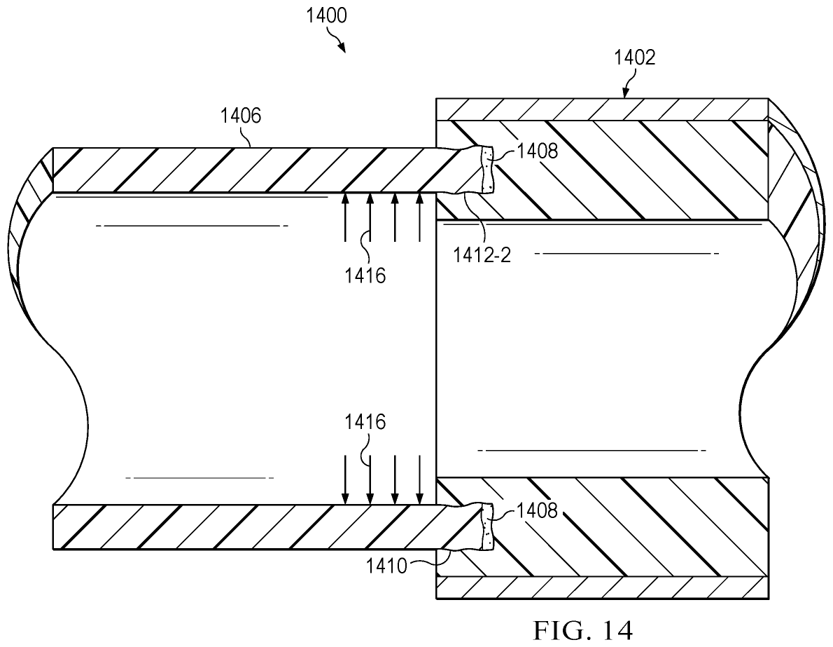

FIG. 14 illustrates a pipe end coupling system 1400. Pipe end coupling system 1400 includes a pipe 1406 connected to a coupling 1402. As seen here, bonds are formed between coupling 1402 and pipe 1406 at three surfaces. Surface 1408 may be contaminated, because of the reinforcing material of pipe 1406. Surface 1410 is around the outer diameter of the pipe and the outer wall of the coupling raceway. This may be an auxiliary bond that is not pressure bearing, but simply provides greater security of the pipe 1406 to coupling 1402.

Incident pressure 1416 impinges on joint 1412, which is between the inner wall of the coupling raceway and the inner diameter wall of the pipe. This is the most critical joint, so to ensure a good bond, the inner diameter of pipe 1406 should be clean, as should the inner wall of the raceway of coupling 1402. Good, clean surfaces and uniform heating at this spot will ensure a good weld between pipe 1406 and coupling 1402, and will thus maintain the pressure rating and bear the pressure 1416.

The foregoing outlines features of several embodiments so that those skilled in the art may better understand various aspects of the present disclosure. The foregoing detailed description sets forth examples of apparatuses, methods, and systems relating to a method and apparatus for bonding reinforced HDPE piping in accordance with one or more embodiments of the present disclosure. Features such as structure(s), function(s), and/or characteristic(s), for example, are described with reference to one embodiment as a matter of convenience; various embodiments may be implemented with any suitable one or more of the described features.

As used throughout this specification, the phrase “an embodiment” is intended to refer to one or more embodiments. Furthermore, different uses of the phrase “an embodiment” may refer to different embodiments. The phrases “in another embodiment” or “in a different embodiment” refer to an embodiment different from the one previously described, or the same embodiment with additional features. For example, “in an embodiment, features may be present. In another embodiment, additional features may be present.” The foregoing example could first refer to an embodiment with features A, B, and C, while the second could refer to an embodiment with features A, B, C, and D, with features, A, B, and D, with features, D, E, and F, or any other variation.

In the foregoing description, various aspects of the illustrative implementations may be described using terms commonly employed by those skilled in the art to convey the substance of their work to others skilled in the art. It will be apparent to those skilled in the art that the embodiments disclosed herein may be practiced with only some of the described aspects. For purposes of explanation, specific numbers, materials, and configurations are set forth to provide a thorough understanding of the illustrative implementations. In some cases, the embodiments disclosed may be practiced without the specific details. In other instances, well-known features are omitted or simplified so as not to obscure the illustrated embodiments.

For the purposes of the present disclosure and the appended claims, the article “a” refers to one or more of an item. The phrase “A or B” is intended to encompass the “inclusive or,” e.g., A, B, or (A and B). “A and/or B” means A, B, or (A and B). For the purposes of the present disclosure, the phrase “A, B, and/or C” means A, B, C, (A and B), (A and C), (B and C), or (A, B, and C).

The embodiments disclosed can readily be used as the basis for designing or modifying other processes and structures to carry out the teachings of the present specification. Any equivalent constructions to those disclosed do not depart from the spirit and scope of the present disclosure. Design considerations may result in substitute arrangements, design choices, device possibilities, hardware configurations, and equipment options.

There are also provided herein certain methods, illustrated for example in flow charts and/or signal flow diagrams. The order or operations disclosed in these methods discloses one illustrative ordering that may be used in some embodiments, but this ordering is no intended to be restrictive, unless expressly stated otherwise. In other embodiments, the operations may be carried out in other logical orders. In general, one operation should be deemed to necessarily precede another only if the first operation provides a result required for the second operation to execute. Furthermore, the sequence of operations itself should be understood to be a nonlimiting example. In appropriate embodiments, some operations may be omitted as unnecessary or undesirable. In the same or in different embodiments, other operations not shown may be included in the method to provide additional results.

In certain embodiments, some of the components illustrated herein may be omitted or consolidated. In a general sense, the arrangements depicted in the FIGURES may be more logical in their representations, whereas a physical architecture may include various permutations, combinations, and/or hybrids of these elements.

With the numerous examples provided herein, interaction may be described in terms of two, three, four, or more components. These descriptions are provided for purposes of clarity and example only. Any of the illustrated components, modules, and elements of the FIGURES may be combined in various configurations, all of which fall within the scope of this specification.

In certain cases, it may be easier to describe one or more functionalities by disclosing only selected elements. Such elements are selected to illustrate specific information to facilitate the description. The inclusion of an element in the FIGURES is not intended to imply that the element must appear in the disclosure, as claimed, and the exclusion of certain elements from the FIGURES is not intended to imply that the element is to be excluded from the disclosure as claimed. Similarly, any methods or flows illustrated herein are provided by way of illustration only. Inclusion or exclusion of operations in such methods or flows should be understood the same as inclusion or exclusion of other elements as described in this paragraph. Where operations are illustrated in a particular order, the order is a nonlimiting example only. Unless expressly specified, the order of operations may be altered to suit a particular embodiment.

Other changes, substitutions, variations, alterations, and modifications will be apparent to those skilled in the art. All such changes, substitutions, variations, alterations, and modifications fall within the scope of this specification.

To aid the United States Patent and Trademark Office (USPTO) and, any readers of any patent or publication flowing from this specification, the Applicant: (a) does not intend any of the appended claims to invoke paragraph (f) of 35 U.S.C. section 112, or its equivalent, as it exists on the date of the filing hereof unless the words “means for” or “steps for” are specifically used in the particular claims; and (b) does not intend, by any statement in the specification, to limit this disclosure in any way that is not otherwise expressly reflected in the appended claims, as originally presented or as amended.

What is claimed is:

1-67. (canceled)

68. A method of heat welding a length of pipe with a coupling, wherein the coupling and the length of pipe are of a thermoplastic material, the method comprising:
preparing a first end of the length of pipe;
preparing a first groove of the coupling, wherein the first groove is configured to mechanically interface to an inner diameter (ID) and outer diameter (OD) of the length of pipe;
heating the first end and the first groove to a weldable temperature;
joining the first end to the first groove; and
permitting the first end and the first groove to cool sufficiently long to form a thermoplastic weld.

69. The method of claim 68, wherein the thermoplastic is high-density polyethylene (HDPE).

70. The method of claim 68, wherein the thermoplastic is a thermoplastic that cannot be readily cemented.

71. The method of claim 68, wherein the thermoplastic is selected from the group consisting of polypropylene (PP), polyethylene (PE), high-density polyethylene (HDPE), low-density polyethylene (LDPE), linear low-density polyethylene (LLDPE), polyethylene terephthalate (PET), polytetrafluoroethylene (PTFE), polycarbonate (PC), and polyvinylidene fluoride (PVDF).

72. The method of claim 68, wherein preparing the first end comprises facing the first end.

73. The method of claim 68, wherein preparing the first end comprises abrading the ID and the OD.

74. The method of claim 68, wherein preparing the first end comprises cleaning with a chemical solvent.

75. The method of claim 68, wherein preparing the first groove comprises facing the first groove.

76. The method of claim 68, wherein preparing the first groove comprises abrading the first groove.

77. The method of claim 68, wherein preparing the first groove comprises cleaning the first groove with a chemical solvent.

78. The method of claim 68, wherein the length of pipe is reinforced.

79. A thermoplastic coupler, comprising:
an outer diameter (OD);
an inner diameter (ID); and
a raceway disposed between the OD and the ID, wherein the raceway has an outer surface configured to mate to an outer sidewall of a thermoplastic pipe, and an inner surface configured to mate to an inner sidewall of the thermoplastic pipe.

80. The thermoplastic coupler of claim 79, wherein the thermoplastic coupler is reinforced by an external sleeve.

81. The thermoplastic coupler of claim 80, wherein external sleeve is fiberglass or metal.

82. The thermoplastic coupler of claim 79, wherein the thermoplastic coupler is a straight coupler.

83. The thermoplastic coupler of claim 79, wherein the thermoplastic coupler is an elbow joint coupler.

84. The thermoplastic coupler of claim 79, wherein the thermoplastic coupler is a tee joint coupler.

85. A heater for a welding a thermoplastic pipe to a thermoplastic coupler, comprising a first face and a second face, wherein the heater is to heat the first face and the second face to one or more temperatures sufficient to heat weld the thermoplastic, and wherein the first face has a grooved surface to receive an end of the thermoplastic pipe, and the second face has a protrusion to receive a groove of the thermoplastic coupler.

86. The heater of claim 85, further comprising an electronic controller to control at least one of heat time and heat temperature.

87. The heater of claim 86, wherein the electronic controller is to heat the first face to a first temperature and the second face to a second temperature, wherein the first temperature and second temperature are different.

88. The heater of claim 86, wherein the electronic controller is to heat the second face for a time δ, and thereafter to heat both the first and second faces for a time t.

89. The heater of claim 85, wherein the first face has a shape and dimensions substantially similar to the thermoplastic coupler.

90. The heater of claim 85, wherein the second face has a shape and dimensions substantially similar to the thermoplastic pipe.
